(19) United States
(12) Patent Application Publication
(10) Pub. No.: US 2015/0303731 A1
(43) Pub. Date: Oct. 22, 2015

(54) Electric Energy Storage Device

(71) Applicant: HITACHI, LTD., Chiyoda-ku, Tokyo (JP)

(72) Inventors: Fumikazu Takahashi, Hitachi (JP); Kimiaki Taniguchi, Hadano (JP); Shouichi Hirota, Hitachi (JP)

(21) Appl. No.: 13/821,025

(22) PCT Filed: Dec. 28, 2012
(86) PCT No.: PCT/JP2012/084182

§ 371 Date: Mar. 6, 2013

(51) Int. Cl. H02J 7/02; H02J 7/00

(52) U.S. Cl. CPC H02J 7/022; H02J 7/0052; H02J 7/0063; H02J 2007/0059

(57) ABSTRACT

In relation to an electric energy storage device or others, a configuration of efficient power feeding means to a control circuit is achieved. A storage device of a present embodiment includes a storage battery; an input/output terminal connectable to a power supply; a power converting device between the storage battery and the terminal; a control unit including a control circuit to controls charge/discharge of the storage battery; a first DC/DC converter connected to a first node between the storage battery and the power converting device and which outputs a first voltage; a second DC/DC converter connected to a second node inside the power converting device and which outputs a second voltage; a first diode connected between the first DC/DC converter and the control circuit; and a second diode connected between the second DC/DC converter and the control circuit. The first voltage and the second voltage are different from each other.

### TECHNICAL FIELD

The present invention relates to a technique of an electric energy storage device and others utilizing a secondary battery or a storage battery. Also, the present invention relates to charge/discharge (charge and discharge) control of the electric energy storage battery.

### BACKGROUND ART

There is an electric energy storage device or an electric energy storage system which is provided with a storage battery such as a lithium-ion secondary battery and controls charge/discharge of the storage battery. In such an electric energy storage device, as a driving state, for example, power is supplied by an AC input from a system power supply in a charge mode to charge the storage battery, and power is supplied to a power load such as an electric appliance by a DC output generated by discharge from the storage battery in a discharge mode. A control circuit provided in the electric energy storage device or a control unit including that monitors the state of the storage battery and controls the charge/discharge of the storage battery.

Examples of prior art techniques relating to the above description are Japanese Patent Application Laid-Open Publication No. 2012-175801 (Patent Document 1), Japanese Patent Application Laid-Open Publication No. 2008-54473 (Patent Document 2), and others.

Patent Document 1 (“Electric Energy Storage System”) describes “to provide an electric energy storage system, whose system efficiency can be improved, and besides, in which overdischarge of a storage battery upon power interruption can be prevented and an operation can be automatically restarted upon recovery from the power interruption”, and describes others. Moreover, it describes that “an electric energy storage system 10 is provided with a storage battery 13, a power converting device 14, and a storage system controller 17, and the electric energy storage system controller 17 performs controls so as to charge the storage battery 13 with power in a specific time zone during nighttime and so as to discharge the storage battery 13 during daytime in which power is fed from a system 11 side upon standby when the charge/discharge of the storage battery 13 is not performed and upon the charge of the storage battery, power is fed from the storage battery 13 side without via the power converting device 14 upon the discharge of the storage battery 13, and this state is switched to the state of the power feeding from the system 11 before the storage battery 13 is overdischarged so as to stop the discharge of the storage battery 13”, and describes others.

Patent Document 2 (“Power Conditioner having Electric Storage Function”) describes “to provide a reliable power conditioner for enabling a commercial power system to be operated during a power interruption, and enabling a (electric) storage cell (battery) to be recovered and charged in a system having three power supplies i.e. a solar cell, the storage cell, and the commercial power system”, and describes others. Moreover, it describes that “The power conditioner is provided with: a power converting circuit for converting DC power from a DC power supply into AC power, a charging/discharging circuit for charging/discharging an electric storage means, the commercial power system for supplying the AC power to a load, and a control circuit for controlling the power converting circuit and the charging/discharging circuit. A power supply selecting circuit selects at least one power supply circuit among a first power supply circuit supplied with drive power from the DC power supply, a second power supply circuit supplied with the drive power from the electric storage means, and a third power supply circuit supplied with the drive power from the commercial power system, and supplies the drive power to the control circuit.”, and describes others.

### PRIOR ART DOCUMENTS

### Patent Documents

Patent Document 1: Japanese Patent Application Laid-Open Publication No. 2012-175801

Patent Document 2: Japanese Patent Application Laid-Open Publication No. 2008-54473

### DISCLOSURE OF THE INVENTION

### Problems to be Solved by the Invention

In an electric storage system of a conventional example, it is required to feed power to a control circuit in order to control the charge/discharge of the storage battery or others. In order to efficiently manage energy of the storage battery, for example, the electric storage system of the Patent Document 1 has a configuration in which a switch (19) is switched to a storage battery (13) side upon discharge from the storage battery (13) such as upon interruption in the system (11) such as power interruption or upon a peak-cut operation so that power is supplied to a control circuit (21) via one DC/DC converter (20). The above-described switch (19) is a switch which switches between the input from the storage battery (13) and the input on the system (11) side via an AC/DC converter (18) so that the power is inputted to a DC/DC converter (20) on a control circuit (21) side. In other words, as described in the example of the Patent Document 1, the electric storage system of the conventional example has a configuration in which switching between the DC input from the storage battery side and the DC input from the system side through the AC/DC conversion is controlled as supplementary power supply means to the control circuit or control means thereof.

In the configuration of the electric storage system of the conventional example as described above, the switch (19) for switching the DC inputs to the control circuit, a drive circuit for the switch, and others are required, and therefore, this requirement causes increase in a cost or others. Moreover, the switching of the above-described switch (19) or others is required in accordance with each operation state or mode of charge/discharge/standby or others, and therefore, this requirement results in complication of the control performed by the control circuit of the electric storage system or others.

In consideration of the above-described points, a main preferred aim of the present invention relates to an electric energy storage device or others, and is to provide a technique which can achieve a configuration of efficient power feeding means or supplementary power supply means to a control circuit, more particularly, achieve reduction in a cost by elimination or reduction in circuits of a switch or others of a DC input and achieve elimination of complicated control of the circuits of the switch or others, automation of the control, simplification of the control, and others.

### Means for Solving the Problems

In order to achieve the above-described preferred aim, a typical embodiment of the present inventions is an electric energy storage device and others having a feature with a configuration described below.

(1) An electric energy storage device of a present embodiment includes: a storage battery; an input/output terminal connectable to a power supply; a power converting device which is provided between the storage battery and the terminal; a control unit including a control circuit which controls charge/discharge to/from the storage battery; a first DC/DC converter which is connected to a first node on wiring between the storage battery and the power converting device and which outputs a first voltage; a second DC/DC converter which is connected to a second node inside the power converting device and which outputs a second voltage different from the first voltage; a first diode which is connected between the first DC/DC converter and the control circuit and to which the first voltage is inputted; and a second diode which is connected between the second DC/DC converter and the control circuit and to which the second voltage is inputted.

(2) For example, the electric energy storage device of the present embodiment has a configuration in which the second voltage is smaller than the first voltage.

(3) For example, the electric energy storage device of the present embodiment has a configuration in which the second voltage is larger than the first voltage.

### EFFECTS OF THE INVENTION

According to the typical embodiment of the present invention, in relation to an electric energy storage device and others, a configuration of efficient power feeding means or supplementary power supply means to a control circuit can be achieved. More particularly, it can achieve reduction in a cost by elimination or reduction in circuits of a switch or others of a DC input and achieve elimination of complicated control of the circuits of the switch or others, automation of the control, simplification of the control, and others.

### BRIEF DESCRIPTIONS OF THE DRAWINGS

FIG. 1 is a diagram illustrating a configuration of an electric energy storage device of a first embodiment of the present invention;

FIG. 2 is a diagram illustrating a configuration of an electric energy storage device of a second embodiment of the present invention;

FIG. 3 is a diagram illustrating a configuration of an electric energy storage device of a third embodiment of the present invention;

FIG. 4 is a diagram illustrating a configuration of an electric energy storage device of a fourth embodiment of the present invention;

FIG. 5 is a diagram illustrating a configuration of an electric energy storage device of a fifth embodiment of the present invention; and

FIG. 6 is a diagram collecting operation states according to embodiments or others.

### BEST MODE FOR CARRYING OUT THE INVENTION

Hereinafter, embodiments of the present invention will be described in detail with reference to the accompanying drawings. Note that the same components are denoted by the same reference symbols in principle throughout all drawings for describing the embodiments, and the repetitive description thereof will be omitted. Note that “DC” represents direct current and “AC” represents alternate current.

### Summary and Others

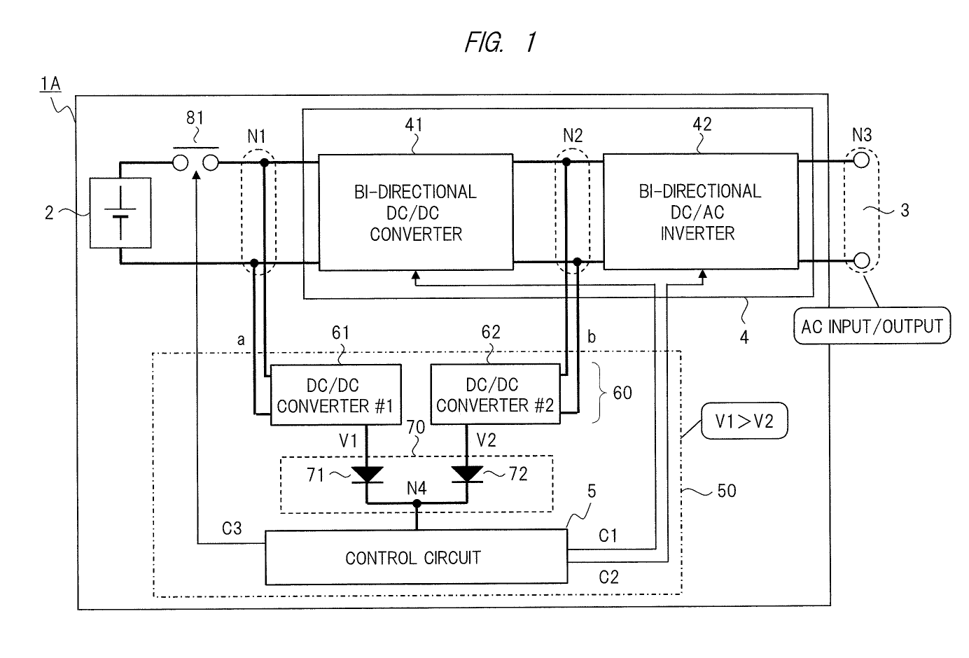

An electric storage system (electric energy storage device 1A in FIG. 1 or others) of the present embodiment has a configuration including efficient power feeding means or supplementary power supply means to a control circuit 5 as follows.

(1) As a DC/DC converter unit 60 which configures the supplementary power supply means of a control unit 50 including the control circuit 5, the present electric energy storage device has a configuration including a first DC/DC converter 61 (#1) which corresponds to a DC input from a storage battery 2 side and a second DC/DC converter 62 (#2) which corresponds to a DC input from a terminal 3 side or a power converting device 4 side in DC or AC electrical wiring lines between the storage battery 2 and the input/output terminal 3. voltages (V1, V2) of DC outputs of the respective DC/DC converters (#1, #2) are connected to diodes 71 and 72 in a forward direction, and DC outputs of the respective diodes 71 and 72 are connected to the control circuit 5. That is, the DC outputs (V1, V2) of the DC/DC converter unit 60 are supplied to the control circuit 5 via a diode OR circuit 70.

It is assumed that a first voltage which is the output voltage of the first DC/DC converter (#1) 61 connected to a node N1 on the above-described storage battery 2 side and is the input voltage of the first diode 71 is “V1”, and assume that a second voltage which is the output voltage of the second DC/DC converter (#2) 62 connected to a node N2 on the above-described power converting device 4 side and is the input voltage of the second diode 72 is “V2”. In the present electric energy storage device, as constituent features, the above-described voltage values (V1, V2) have a relation of different values from each other, one of which is higher than the other (V1≠V2, V1>V2 or V1<V2). In this manner, the device has a mechanism in which the two DC inputs to the control circuit 5 on the storage battery 2 side and the terminal 3 side are automatically switched via the DC/DC converter unit 60 and the diode OR circuit 70. Among the two inputs (V1, V2), the higher voltage is preferentially supplied to the control circuit 5. The above-described voltage values (V1 and V2) may be a form of a previously-fixed design value or a variable setting form as described later.

(2) Also, for example, the present electric energy storage device (of a first embodiment described later) has a configuration in which the output voltage V1 of the DC/DC converter (#1) 61 on the storage battery 2 side is designed to be a voltage higher than the output voltage V2 of the DC/DC converter (#2) 62 on the power converting device 4 side. That is, a configuration “A” is designed so that “V1>V2”. In the case of the configuration A, the DC input from the storage battery 2 side is preferentially fed to the control circuit 5 via the DC/DC converter (#1) 61.

(3) Further, for example, the present electric energy storage device (of a second embodiment described later) has a configuration in which the output voltage V1 of the DC/DC converter (#1) 61 on the storage battery 2 side is designed to be a voltage lower than the output voltage V2 of the DC/DC converter (#2) 62 on the power converting device 4 side. That is, a configuration “B” is designed so that “V1<V2”. In the case of the configuration B, the DC input from the terminal 3 side is preferentially fed to the control circuit 5 via the DC/DC converter (#2) 62 side.

(4) Still further, for example, in the present electric energy storage device (of the first embodiment described later or others), the terminal 3 is a terminal corresponding to AC input/output and is connected to a system power supply or others, and the power converting device 4 is a device corresponding to AC input/output. Alternatively, in the present electric energy storage device (of a third embodiment described later), the terminal 3 is a terminal corresponding to DC input/output and is connected to a power supply corresponding to DC input/output or others, and the power converting device 4 is a device corresponding to DC input/output.

(5) Still further, for example, the present electric energy storage device (of a fourth embodiment described later) includes a setting unit which variably sets the output voltage values (V1, V2) of the above-described DC/DC converter unit 60. For example, the above-described voltage values (V1, V2) can be variably set by a control signal from the control circuit 5 to the respective DC/DC converters (#1, #2). By the present setting unit, the configuration A (V1>V2) and the configuration B (V1<V2) can be also switched.

(6) Still further, for example, the present electric energy storage device (of the first embodiment described later or others) has a configuration in which a switch 81 on the storage battery 2 side is turned off in a standby operation (in a standby mode described later) by a control signal from the control circuit 5 so that the power is fed from the input from the terminal 3 side to the control circuit 5 via the DC/DC converter (#2) 62.

(7) Still further, for example, in the present electric energy storage device (of a fifth embodiment described later), a switch for an autonomous operation (an autonomous operation mode described later) which is operable by a user from outside is provided in a package or others. In a state that the terminal 3 side is not connected, the switch 81 on the storage battery 2 side is turned on by pushing the switch 9 by the user. In this manner, the power is fed to the control circuit 5 via the DC/DC converter (#1) 61 by the DC output generated by the discharge of the storage battery 2.

In this manner, the present electric storage system can be started by the control circuit 5. For example, the present autonomous operation mode can be operated in a state that the terminal 3 is not connected to the system power supply or others, such as in shipment of the present electric energy storage device or maintenance thereof, and this is useful for confirmation working or others.

### First Embodiment

FIG. 1 illustrates the configuration of the electric energy storage device 1A which is the electric storage system of the first embodiment. The present electric energy storage device 1A has a configuration including: the storage battery 2; the input/output terminal 3; the power converting device 4; the control unit 50 including the control circuit 5; the DC/DC converter unit 60 including the first DC/DC converter (#1) 61 and the second DC/DC converter (#2) 62; the diode OR circuit 70 including the first diode 71 and the second diode 72; and the switch 81. The storage battery (battery) 2 is configured of a secondary battery pack formed of, for example, a lithium-ion secondary battery or others. The switch 81 is a switchgear and is provided on a direct-current path between the storage battery 2 and a bi-directional DC/DC converter 41 of the power converting device 4. The switch 81 determines the state that the charge/discharge of the storage battery 2 is enabled or disabled. The node N1 is provided between the switch 81 and the bi-directional DC/DC converter 41. A direct-current path (a) branched from the node N1 is connected to the first DC/DC converter 61. The turning on/off of the switch 81 are switched and controlled by a control signal C3 from the control circuit 5. For example, the switch 81 is turned off in the standby mode, and is turned on in the charge mode and the discharge mode.

In the first embodiment, the terminal 3 is a terminal corresponding to AC power-supply connection or AC input/output. A node which corresponds to the terminal 3 is assumed to be “N3”. The terminal 3 may be assumed to be a connection cable or others. In the first embodiment, to the terminal 3, an AC input of the system power supply, a power-supply load corresponding to AC input such as an electric appliance, or others is appropriately connected.

The power converting device 4 has a configuration that the bi-directional DC/DC converter 41 and a bi-directional DC/AC inverter 42 are connected in a DC or AC wiring line between the storage battery 2 and the terminal 3. In the first embodiment, the bi-directional AC/DC inverter 42 is provided in the power converting device 4 so as to correspond to the AC input/output of the terminal 3. The power converting device is connected to the DC/DC converter unit 60 by direct-current paths (a, b) branched from the nodes Ni and N2 on both sides of the bi-directional DC/DC converter 41. The node N2 is provided on the direct-current paths between the bi-directional DC/DC converter 41 and the bi-directional DC/AC inverter 42. The direct-current path (b) branched from the node N2 is connected to the second DC/DC converter 62. Each of the bi-directional DC/DC converter 41 and the bi-directional DC/AC inverter 42 controls a direction of the charge/discharge in an internal circuit or others based on control signals (C1, C2) from the control circuit 5. Upon the charge of the storage battery 2, a DC input from the terminal 3 and the 42-side node N2 is subjected to DC/DC conversion by the bi-directional DC/DC converter 41, and is outputted to the node N1. Also, upon the discharge of the storage battery 2, a DC input from the storage battery 2 and the switch-81-side node N1 is subjected to DC/DC conversion, and is outputted to the node N2. Upon the charge of the storage battery 2, an AC input from the terminal-3-side node N3 is subjected to AC/DC conversion by the bi-directional DC/AC inverter 42, and is outputted to the node N2. Also, upon the discharge of the storage battery 2, a DC input from the 41-side node N2 is subjected to DC/AC conversion, and is outputted to the terminal-3-side node N3.

The control unit 50 has a configuration including: the control circuit 5; the DC/DC converter unit 60 (61, 62); and the diode OR circuit 70 (71, 72). The efficient power-feeding mechanism to the control circuit 5 includes the two DC/DC converters 61 and 62 and the diodes 71 and 72 which are associated with and connected to the storage battery 2 side (N1) and the terminal 3 side (N2), respectively. This is a mechanism in which the power feeding to the control circuit 5 is automatically switched by using them.

The control circuit 5 controls the entire electric energy storage device 1A as control of monitoring or protection of a state of the storage battery 2 or others and control of the charge/discharge to/from the storage battery 2 via the power converting device 4. Each control is achieved by applying a control signal from the control circuit 5 to each unit. For example, by applying the control signals (C1, C2) from the control circuit 5 to the respective units (41, 42) of the power converting device 4, the direction of the power conversion caused along with the charge/discharge or others is controlled. For example, the AC input from the system power supply of the terminal 3 is converted into DC by the bi-directional AC/DC inverter 42, its DC output is converted into DC by the bi-directional DC/DC converter 41, and its DC output is supplied to the storage battery 2 for the charge. Alternatively, for example, the DC output caused by the discharge from the storage battery 2 is converted into DC by the bi-directional DC/DC converter 41, and its DC output is converted into AC by the bi-directional AC/DC inverter 42, and is supplied to the power-supply load connected to the terminal 3 or others. Further, by applying a control signal C3 from the control circuit 5 to the switch 81 on the storage battery 2 side, the turning on/off of the switch 81 are switched.

The DC/DC converter unit 60 includes the two DC/DC converters (#1) 61 and (#2) 62 as the supplementary power-supply means of the control circuit 5. In the first DC/DC converter (#1) 61, its input DC side is connected to the node N1 on the direct-current path on the storage battery 2 side, and its output DC side is at the first voltage V1 and is connected to the first diode 71. In the second DC/DC converter (#2) 62, its input DC side is connected to the node N2 on the direct-current path inside the power converting device 4 on the terminal 3 side, and its output DC side is at the second voltage V2 and is connected to the second diode 72.

The diode OR circuit 70 includes the two diodes 71 and 72, and the corresponding diodes 71 and 72 are connected to the respective outputs (V1, V2) of the DC/DC converter unit 60 (61, 62) in the forward direction. The diodes 71 and 72 have characteristics corresponding to the above-described voltage values V1 and V2 (V1 V2). An output node N4 of the diode OR circuit 70 (71, 72) is connected to the control circuit 5. A value of the output node N4 of the diode OR circuit 70 is the higher one of the two input voltage values (V1, V2). That is, the higher one of the voltage values (V1, V2) of the DC power from the storage battery 2 side and the DC power from the terminal 3 side is preferentially fed to the control circuit 5.

### Configuration A (V1>V2)

In the first embodiment, the DC/DC converter unit 60 and the diode OR circuit 70 of the control unit 50 have the above-described configuration A in the voltage values (V1>V2) in which the DC power on the storage battery 2 side is preferentially used to be fed to the control circuit 5. If the DC/DC converter unit 60 has both of the DC input (a) from the storage battery 2 side to the DC/DC converter (#1) 61 in the turning-on state of the switch 81 and the DC input (b) from the terminal 3 side to the DC/DC converter (#2) 62 through the conversion of the AC input such as the charge/discharge modes, the configuration A functions as follows. That is, since the relation of “V1>V2” is established, if the diode OR circuit 70 has the two inputs (V1, V2), the output on the V1 side is preferentially used. That is, the voltage V1 on the DC/DC converter (#1) 61 side is preferentially fed to the control circuit 5.

In this manner, in the discharge mode, the configuration A has an advantage in that efficiency in energy utilization is high when the DC power is supplied from the storage battery 2 side to the control circuit 5 via the DC/DC converter (#1) 61. In the AC output caused by the discharge from the storage battery 2 to the terminal 3 side via the power converting device 4, the power conversion for the power feeding to the control circuit 5 is performed by only one step, that is, only the DC/DC conversion by the DC/DC converter (#1) 61, and therefore, the efficiency in the power conversion is high.

Also, in the present configuration, if an electric storage amount of the storage battery 2 is insufficient, the power feeding is automatically switched to the DC input from the terminal 3 side via the DC/DC converter (#2) 62.

According to the electric energy storage device 1A of the first embodiment, the automatic switching mechanism is achieved with using the DC/DC converter unit 60 (61, 62) or others as the configuration of the efficient power feeding means or supplementary power supply means to the control circuit 5 which is different from the configuration of the conventional example as described in the Patent Document 1 or others. More particularly, the circuits for the switch or others of the DC input of the conventional example can be eliminated or reduced, and therefore, a low-cost electric storage system can be achieved. Moreover, the complicated control of the above-described circuits for the switch or others can be eliminated, or automation of the control, simplification of the control, and others can be achieved.

### Second Embodiment

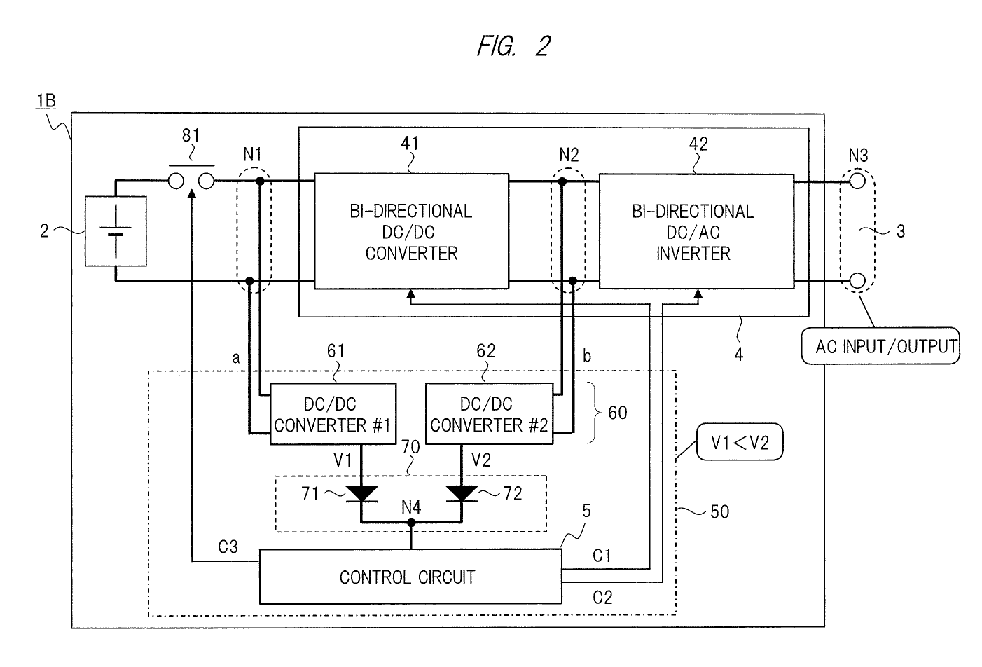

FIG. 2 illustrates a configuration of an electric energy storage device 1B of a second embodiment. The second embodiment has the above-described configuration “B” with the voltage values (V1<V2) in the control unit 50 as a different point from the first embodiment (FIG. 1).

### Configuration B (V1<V2)

In the second embodiment, the DC/DC converter unit 60 and the diode OR circuit 70 of the control unit 50 have the above-described configuration B with the voltage values (V1<V2) in which the DC power from the terminal 3 side through the AC/DC conversion is preferentially used to be fed to the control circuit 5. If the DC/DC converter unit 60 has both of the DC input (a) from the storage battery 2 side to the DC/DC converter (#1) 61 in the turning-on state of the switch 81 and the DC input (b) from the terminal 3 side to the DC/DC converter (#2) 62 through the conversion of the AC input such as the charge/discharge modes, the configuration B functions as follows. That is, since the relation of “V1<V2” is established, if the diode OR circuit 70 has the two inputs (V1, V2), the output on the V2 side is preferentially used. That is, the voltage V2 on the DC/DC converter (#2) 62 side is preferentially fed to the control circuit 5.

In this manner, in the charge mode, the configuration B has an advantage in that efficiency in energy utilization is high when the DC power is supplied from the terminal 3 side to the control circuit 5 via the DC/DC converter (#2) 62. In the charge of the storage battery 2 by the system power supply connected to the terminal 3 through the DC by the power converting device 4, the power conversion for the DC power feeding to the control circuit 5 is performed by only one step, that is, only the DC/DC conversion by the DC/DC converter (#2) 62, and therefore, the efficiency in the power conversion is high.

Also, the input from the system power supply on the terminal 3 side is preferentially used as a result, and therefore, DC power consumption of the storage battery 2 can be suppressed. Moreover, in the present configuration, the power feeding is automatically switched from the above-described terminal-3-side DC input (b) to the DC input (a) via the DC/DC converter (#1) 61 caused by the discharge from the storage battery 2 side in interruption of the AC input of the terminal 3 such as the power interruption of the system power supply.

### Third Embodiment

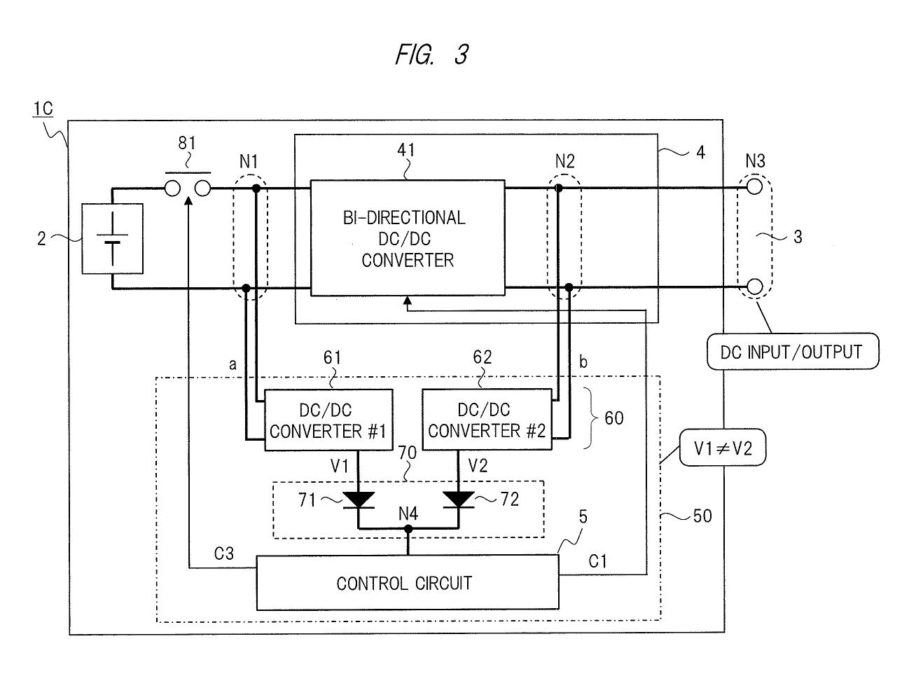

FIG. 3 illustrates a configuration of an electric energy storage device 1C of a third embodiment. In the electric energy storage device 1C of the third embodiment, the terminal 3 is a terminal corresponding to the DC connection or the DC input/output.

In accordance with this, the power converting device 4 has a configuration including the bi-directional DC/DC converter 41 without requiring the above-described bi-directional DC/AC inverter 42. The DC input of the terminal 3 is connected to the second DC/DC converter 62 through the direct-current path (b) branched from the node N2 between the terminal 3 and the bi-directional DC/DC converter 41. The DC/DC converter unit 60 has the configuration with the relation of “V1≠V2” as similar to the above description. Also in the third embodiment, similar effects to those of the first embodiment can be obtained.

### Fourth Embodiment

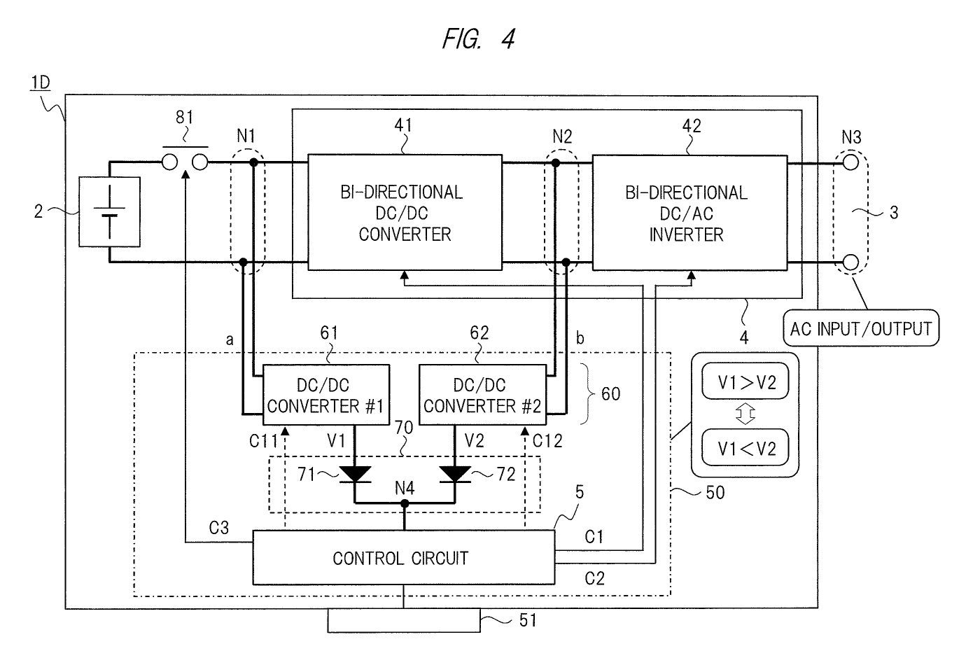

FIG. 4 illustrates a configuration of an electric energy storage device 1D of a fourth embodiment. The fourth embodiment has a configuration with the setting unit in which the voltage values (V1, V2) of the DC/DC converter unit 60 can be variably set. The fourth embodiment can be achieved by, more particularly, a setting interface unit 51 and a setting processing function owned by the control circuit 5 as the above-described setting unit for the voltage values. The setting interface unit 51 is, for example, an operation panel which is provided in a package, which is connected to the control circuit 5, and which can perform the setting operation by a user. The user can input/specify the set values for the above-described voltage values (V1, V2), selection of the operation state or mode, or other set values of the present electric energy storage device, or others in the setting interface unit 51.

The setting processing function of the control circuit 5 provides control signals (C11, C12) to the DC/DC converter unit 60 (61, 62) in accordance with the input/specification of the above-described set values of the voltage values (V1, V2) in the setting interface unit 51. In this manner, the output voltage values (V1, V2) of the respective DC/DC converters (61, 62) can be variably set.

Also, the control circuit 5 may appropriately change the output voltage values (V1, V2) of the respective DC/DC converters (61, 62) in accordance with the predetermined control for the charge/discharge of the storage battery 2 by judgment itself. For example, the above-described configuration A (V1>V2) and the configuration B (V1<V2) can be switched for the above-described setting of the voltage values (V1, V2) in accordance with the switching of the modes such as the charge/discharge to/from the storage battery 2. In this manner, the efficiency in the energy utilization is improved.

### Fifth Embodiment

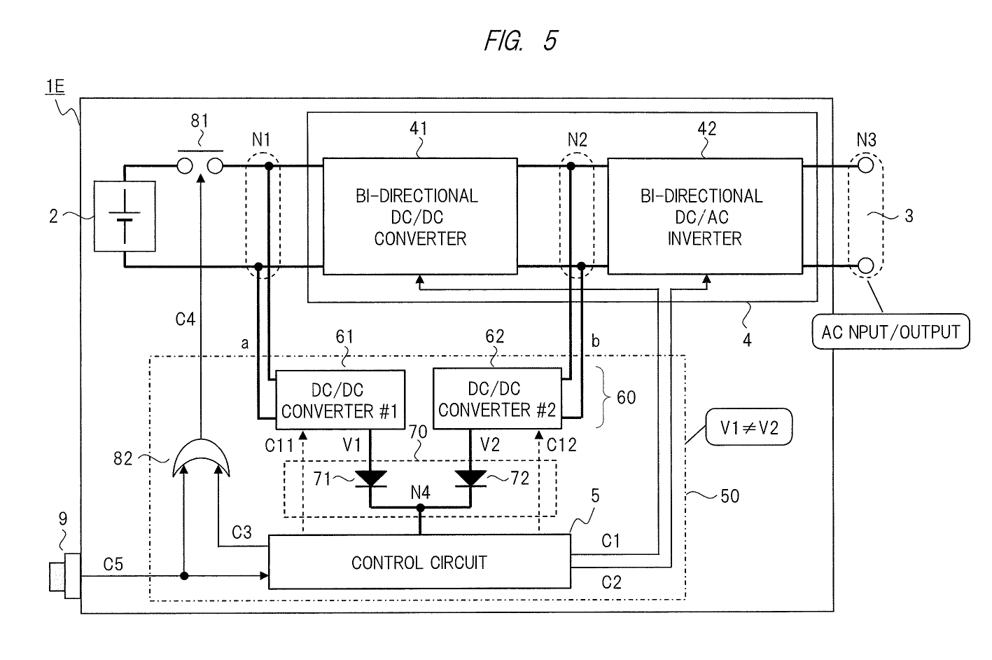

FIG. 5 illustrates a configuration of an electric energy storage device 1E of a fifth embodiment. In the electric energy storage device 1E of the fifth embodiment, a circuit unit including a switch 9 for the autonomous operation is further provided on the assumption of the configuration of the first embodiment or others as additional means and mechanism, so that operation in the autonomous operation mode can be performed by pushing down the switch 9 by the user. Moreover, the electric energy storage device has a mechanism in which the control circuit 5 recognizes the pushing down of the switch 9 by the user.

The switch 9 for the autonomous operation is provided in a button form or others which can be manually operated by the user from outside in a package of the electric energy storage device 1E or others. When the switch 9 is pushed down (on) by the user, a control signal “C5” indicating the pushing down (on) is inputted to one of input terminals of an OR circuit 82, and is inputted to the control circuit 5. The control signal C3 as similar to the above description is inputted from the control circuit 5 to the other of the input terminals of the OR circuit 82. Then, a control signal “C4” of the OR output of the OR circuit 82 is inputted to the above-described switch 81 so as to switch between the on/off states as similar to the above description.

By pushing down the switch 9 by the user in a state that the system power supply or others is not connected to the terminal 3 of the electric energy storage device 1E, the switch 81 is turned on via the OR circuit 82. In this manner, the power is fed from the DC output from the storage battery 2 to the control circuit 5 via the DC/DC converter (#1) 61, and therefore, the control circuit 5 can be activated. Also, a control signal “C5” generated by the pushing down of the switch 9 is inputted to and recognized by the control circuit 5. The control circuit 5 activated by the power feeding operates in the autonomous operation mode based on the recognition of the pushing down of the switch 9.

As a usage example of the electric energy storage device 1E of the fifth embodiment, in shipment/inspection or in maintenance after manufacturing/assembling of the present device, the autonomous operation mode can be started by pushing down the switch 9 by the user (who is an inspection worker or others) in the state that the terminal 3 is not connected as described above. The confirmation working of the device operation or others can be performed in this state, and therefore, the invention is useful.

According to the electric energy storage device 1E of the fifth embodiment, the autonomous operation mode can be achieved as described above, so that expandability of an operation scheme can be achieved in addition to the usefulness in the inspection or others.

### Operation State

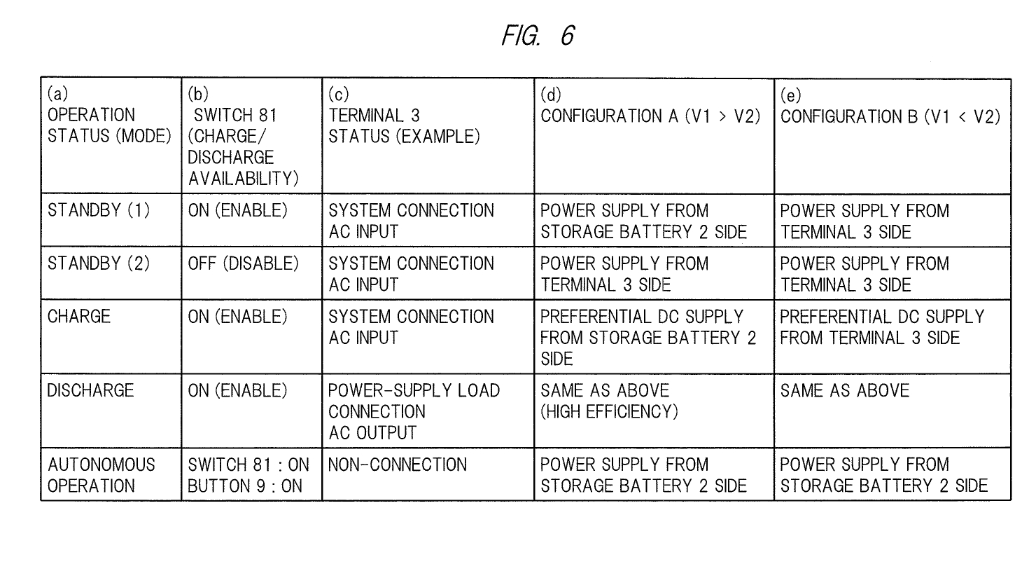

FIG. 6 collectively illustrates each operation state in the electric energy storage device (1A or others) of each of the above-described embodiments and others in a table. As illustrated in the drawing, the operation state or mode of the electric energy storage device includes the standby, charge, discharge, autonomous operations, and others. Note that a completely-stopped state is excluded. Also, the standby mode can include two types indicated by “standby (1)” and “standby (2)”. The control circuit 5 controls these modes. In items of the table, an item (a) indicates the above-described operation state or mode. An item (b) indicates a state that the charge/discharge is enabled or disabled depending on the turning-on/off states of the switch 81. An item (c) indicates a state example such as the connection of the input/output terminal 3 or others. An item (d) indicates the case of the configuration A (V1>V2) as described in the first embodiment. An item (e) indicates the case of the configuration B (V1<V2) as described in the second embodiment. Note that the case of the AC connection is illustrated as described in the first and second embodiments or others.

The electric energy storage device of the first embodiment or others is activated by the power feeding to each unit including the control circuit 5 through the AC input generated by the connection of the system power supply to the terminal 3 or others, and the mode is transited to the standby mode first. In the standby mode, in the case of the standby (1) mode, the switch 81 is basically turned on (enabled). In the case of the standby (2) mode, the switch 81 is basically turned off (disabled). The standby mode is transited to the charge mode or the discharge mode by the control circuit 5 at predetermined timing.

In the case of the standby (1) mode, the switch 81 is turned on by the control signal C3 from the control circuit 5 so as to enable the charge/discharge of the storage battery 2. In the case of the configuration A, the power is fed to the control circuit 5 via the

DC/DC converter (#1) 61 based on the DC output from the storage battery 2 side. In the case of the configuration B, the power is fed to the control circuit 5 via the DC/DC converter (#2) 62 based on the AC input from the system connection on the terminal 3 side. In the case of the standby (2) mode, the switch 81 is turned off by the control signal C3 from the control circuit 5 so as to disable or interrupt the charge/discharge of the storage battery 2, so that, in both of the configuration A and the configuration B, the power is fed to the control circuit 5 via the DC/DC converter (#2) 62 based on the AC input from the system connection on the terminal 3 side.

Also, in the case of the fifth embodiment, the switch 81 is turned on by pushing down the switch 9 for the autonomous operation by the user in the state that the terminal 3 is not connected as described above, so that the control circuit 5 is activated by the power feeding from the storage battery 2 side via the DC/DC converter (#1) 61, and the operation in the autonomous operation mode is performed.

In the charge mode, the switch 81 is turned on so that the storage battery 2 is charged by the DC input via the power converting device 4 through the AC input caused by the connection of the system power supply to the terminal 3. In the case of the configuration A (V1>V2), the power is preferentially fed from the storage battery 2 side to the control circuit 5 via the DC/DC converter (#1) 61. In the case of the configuration B (V1<V2), the power is preferentially fed to the control circuit 5 from the terminal 3 side via the DC/DC converter (#2) 62. In the case of the configuration

B, the power feeding from the terminal 3 side is highly efficient as described above.

In the discharge mode, the switch 81 is turned on so that the DC power generated by the discharge from the storage battery 2 is converted to the AC output or others via the power converting device 4, and is fed to the power-supply load connected to the terminal 3 side or others. In the case of the configuration A (V1>V2), the power is preferentially fed from the storage battery 2 side to the control circuit 5 via the DC/DC converter (#1) 61. In the case of the configuration A, the power feeding from the storage battery 2 side is highly efficient as described above. Also, in the case of the configuration B (V1<V2), the power is preferentially fed from the terminal 3 side to the control circuit 5 via the DC/DC converter (#2) 62.

Further, an example of the control of the operation state or others in the case of the connection of the system power supply to the above-described terminal 3 in the electric energy storage device will be described below.

(1) In the case of the connection of the system power supply to the terminal 3, the DC/DC converter (#2) 62 is preferentially operated so that the DC input through the AC/DC conversion from the system side is fed to the control circuit 5. In the case of the second embodiment, by the configuration B (V1<V2), the input via the DC/DC converter (#2) 62 is automatically preferential as described above. Also, as, for example, the fourth embodiment, the state may be switched to the configuration B (V1<V2) by providing the control signal C12 to the DC/DC converter (#2) 62. In this manner, the efficiency in the energy utilization can be improved.

In the discharge operation from the storage battery 2, the switch 81 is turned on, and besides, the DC/DC converter (#1) 61 is preferentially operated so as to feed the power to the control circuit 5. In the case of the first embodiment, by the configuration A (V1>V2), the input via the DC/DC converter (#1) 61 is automatically and preferentially used as described above. Further, as, for example, the fourth embodiment, the state may be switched to the configuration A (V1>V2) by providing the control signal C11 to the DC/DC converter (#1) 61. In this manner, the efficiency in the energy utilization can be improved.

(2) In the autonomous operation mode, the power is not fed from the DC/DC converter (#2) 62 side to the control circuit 5 because the system is not connected to the terminal 3, and therefore, the power on the DC/DC converter (#1) 61 side, that is, the power generated by the discharge from the storage battery 2 side is necessarily supplied. In the autonomous operation mode, along with turning on the switch 9 and the switch 81, the bi-directional DC/DC converter 41 of the power converting device 4 starts the output through the DC/DC conversion or the discharging operation, so that the power is temporarily fed from the DC/DC converter (#2) 62 side to the control circuit 5 via the node N2. However, by taking the configuration in which the power is preferentially fed from the DC/DC converter (#1) 61 side via the node N1 because of the configuration A (V1>V2) or the switching control to the state of the configuration A by the control circuit 5, the efficiency in the energy utilization can be improved as similar to the above description.

In the case that the switch 81 is basically turned off as the above-described standby (2) mode and if the system power supply is stopped or interrupted in the standby state, note that the power is not fed to the control circuit 5 so that the electric energy storage device is stopped, and this is not desirable. Accordingly, the following configuration of the electric energy storage device may be taken. The power converting device 4 is provided with a function of detecting the power stop or interruption of the system power supply connected to the terminal 3, and issues a discharge start command to the control circuit 5 when the power interruption is detected by the function. In accordance with the command, the control circuit 5 switches the switch 81 from the turning-off state to the turning-on state while the voltage of the node N2 is maintained in a capacitor inside the power converting device 4 for a certain period of time. In this manner, the power is fed to the control circuit 5 by starting the discharge from the storage battery 2.

### Supplement

Insulation properties of the power converting device 4 (41, 42) and other units will be supplemented. In the present embodiment, the storage battery 2 side and the system power supply side of the terminal 3 or others are insulated from each other by the bi-directional DC/DC converter 41 or the bi-directional DC/AC inverter 42 in the power converting device 4 in consideration of a viewpoint of ensuring safety. That is, the power converting device 4 has an insulating function. Note that the insulation can be achieved by a publicly-known technique such as a transformer. Also in the DC/DC converter unit 60 (61, 62) of the control circuit unit 50, a form having the insulating function is desirable in a viewpoint similar to the above description.

In the forgoing, the invention made by the present inventors has been concretely described based on the embodiments. However, the present invention is not limited to the above-described embodiments. However, it is needless to say that the present invention is not limited to the foregoing embodiments and various modifications and alterations can be made within the scope of the present invention.

The present invention can be utilized in various electric storage systems for household use, building use, factory use, and others.

### SYMBOL EXPLANATION

1A . . . electric energy storage device, 2 . . . storage battery, 3 . . . terminal, 4 . . . power converting device, 5 . . . control circuit, 9 . . . switch, 41 . . . bi-directional DC/DC converter, 42 . . . bi-directional DC/AC inverter, 50 . . . control unit, 51 . . . setting interface unit, 60 . . . DC/DC converter unit, 61 and 62 . . . DC/DC converter, 70 . . . diode OR circuit, 71 and 72 . . . diode, 81 . . . switch, and 82 . . . OR circuit

1. An electric energy storage device comprising:
a storage battery;
an input/output terminal connectable to a power supply;
a power converting device which is provided between the storage battery and the terminal;
a control unit including a control circuit which controls charge/discharge to/from the storage battery;
a first DC/DC converter which is connected to a first node on wiring between the storage battery and the power converting device and which outputs a first voltage;
a second DC/DC converter which is connected to a second node inside on a direct-current path of the power converting device and which outputs a second voltage different from the first voltage;
a first diode which is connected between the first DC/DC converter and the control circuit and which takes the first voltage as an input; and
a second diode which is connected between the second DC/DC converter and the control circuit and which takes the second voltage as an input.

2. The electric energy storage device according to claim 1,
wherein the second voltage is smaller than the first voltage.

3. The electric energy storage device according to claim 1,
wherein the second voltage is larger than the first voltage.

4. The electric energy storage device according to claim 1,
wherein the electric energy storage device includes a setting unit which variably sets values of the first voltage and the second voltage.

5. The electric energy storage device according to claim 4,
wherein the setting unit includes an interface unit in which the values of the first voltage and the second voltage can be set by a user operation, and
the control unit sets voltage values of the first DC/DC converter and the second DC/DC converter in accordance with the set values in the interface unit.

6. The electric energy storage device according to claim 1,
wherein the terminal is a terminal which is connected to an AC power supply and to/from which AC power is inputted/outputted,
the power converting device includes:
a bi-directional DC/DC converter having a function of taking a first DC voltage from the storage battery side as an input and converting the first DC voltage into a second DC voltage and a function of taking the second DC voltage as the input and converting the second DC voltage into the first DC voltage; and
a bi-directional DC/AC inverter having a function of taking an AC voltage from the terminal side as an input and converting the AC voltage into the second DC voltage and a function of taking the second DC voltage as the input and converting the second DC voltage into an AC voltage to the terminal side.

7. The electric energy storage device according to claim 1,
wherein the terminal is a terminal which is connected to a DC power supply and to/from which DC power is inputted/outputted,
the power converting device includes:
a bi-directional DC/DC converter having a function of taking a first DC voltage from the storage battery side as an input and converting the first DC voltage into a second DC voltage to the terminal side and a function of taking a second DC voltage from the terminal side as the input and converting the second DC voltage into a first DC voltage to the storage battery side.

8. The electric energy storage device according to claim 1,
wherein the electric energy storage device includes:
a first switch between the storage battery and the power converting device, and
the control unit turns off the first switch as a standby mode, and DC power generated based on an input on the terminal side is fed to the control unit via the second DC/DC converter.

9. The electric energy storage device according to claim 1,
wherein the electric energy storage device includes:
a first switch provided on wiring between the storage battery and the power converting device; and
a second switch for autonomous operation which is operable by a user,
the first switch is turned on by pushing down the second switch by the user in a state that a power supply is not connected to the terminal, and DC power generated by discharge on the storage battery side is fed to the control unit via the first DC/DC converter so that the control unit is activated.

10. The electric energy storage device according to claim 9,
wherein the control circuit is activated by the supply of the DC power generated by the discharge on the storage battery side, takes a signal generated by the pushing down of the second switch as an input, and performs operation and control as an autonomous operation mode.
